(19) United States
(12) Patent Application Publication
(10) Pub. No.: US 2003/0236866 A1
(43) Pub. Date: Dec. 25, 2003

(54) Self-surveying wireless network

(75) Inventor: John J. Light, Beaverton, OR (US)

Correspondence Address: Pillsbury Winthrop LLP, Intellectual Property Group, 1600 Tysons Boulevard, McLaean, VA, 22102, US

(73) Assignee: Intel Corporation, Santa Clara, CA

(21) Appl. No.: 10/178,104

(22) Filed: Jun. 24, 2002

(51) Int. Cl. G06F 15/177

(52) U.S. Cl. 709/220

(57) ABSTRACT

A wireless node capable of self-configuring a wireless network includes an ultra-wideband (UWB) transceiver and an antenna coupled to the UWB transceiver. A logic circuit is adapted to automatically establish the wireless network with at least one of a plurality of wireless nodes based on UWB signals having distance information transmitted by the plurality of wireless nodes. The locations of the plurality of wireless nodes are calculated based on the distance information.

### BACKGROUND

1. Technical Field

An embodiment of the present invention relates to development and deployment of wireless networks. More particularly, an embodiment of the present invention relates to self-surveying wireless sensor networks utilizing ultra-wideband (UWB) wireless nodes.

2. Discussion of the Related Art

Sensor networks have numerous applications, such as security, industrial monitoring, military reconnaissance, and biomedical monitoring. In many such applications, it is either inconvenient or impossible to connect the sensors by wire or cable; a wireless network is preferable. Sensor networks may be implemented indoors or outdoors. Seismic sensors, for example, may be used to detect intrusion or movement of vehicles, personnel, or large earth masses (e.g., tectonic plates).

The detection of vehicles and personnel is more difficult than detecting large signals, as from earthquakes or movement of earth masses. Quiet vehicles and personnel movement produce seismic signals that may not be detectable by geophones at ranges of more than tens of meters, particularly in the presence of background noise. The reliable detection or tracking over large areas thus requires very large numbers of sensitive detectors, spaced closely. The placement of such large numbers of conventional detectors is generally inconvenient, expensive and time consuming if they must be wired for communication or power supply. A wireless network of numerous sensitive, low cost, low-powered sensor stations is more desirable.

Although placing sensor nodes in the environment is relatively easy, and configuring them in a network is manageable, a problem faced by sensor networks is that determining where they are in geographic coordinate locations is difficult and expensive. One solution to this problem is to walk around with a Global Positioning System (GPS) module and activate each sensor while near it, then correlate the activations with the time sequenced location of the GPS receiver. Besides being labor intensive, the problem of GPS reception inside a building, for example, makes this approach impractical.

### BRIEF DESCRIPTION OF THE DRAWINGS

FIG. 1 illustrates a wireless node according to an embodiment of the present invention;

FIG. 2 illustrates a wireless self-surveying/self-configuring network according to an embodiment of the present invention;

FIG. 3 illustrates a flow chart diagram of self-configuring a wireless network according to an embodiment of the present invention; and

FIG. 4 illustrates a flow chart diagram of self-configuring a wireless network by a wireless node according to an embodiment of the present invention.

### DETAILED DESCRIPTION

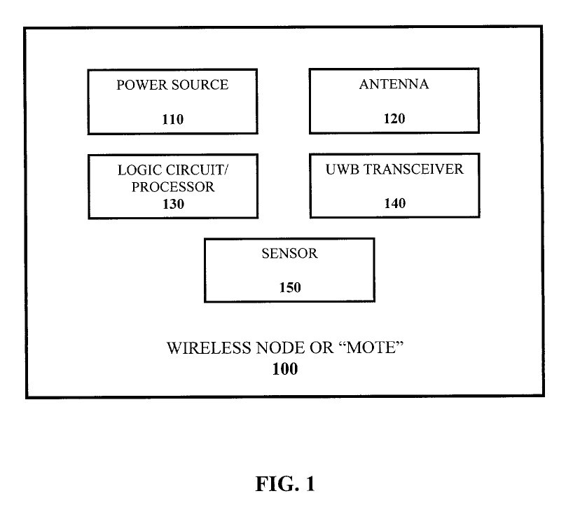

FIG. 1 illustrates a wireless node according to an embodiment of the present invention. The wireless node 100, also known as a “mote”, is the basic unit of a wireless network. The wireless node 100 may be of various sizes, and may be as small as that of a quarter coin. According to an embodiment of the present invention, the wireless node 100 includes a power source 110, a logic circuit/processor 130, an ultra-wideband (UWB) transceiver 140, an antenna 120 coupled to the UWB transceiver 140, and a sensor 150.

The power source 110 provides power to the wireless node 100. For example, the power source 110 may be a battery, a solar-powered cell, or a continuous power supply connected to a power line. The ultra-wideband (UWB) transceiver 140 is adapted to transmit and receive UWB signals. Ultra-wideband (Revision of Part 15 of the Commission's Rules Regarding Ultra-Wideband Transmission Systems, FCC 02-48, Federal Communications Commission, ET Docket 98-153, released Apr. 22, 2002) utilizes extremely low power radio pulses (50 millionths of a watt) that extend across a wide spectrum of radio frequency bands to transmit digital data. Because UWB transmits the pulses at such low power and across such a broad frequency range, and because the pulses are so short (half a billionth of a second), receivers listening for transmission at specific frequencies perceive them as mere background noise. UWB operates on a timed pulse system. That is, the transmitter and receiver of UWB signals operate on a same code that governs the intervals of the pulses so as to determine whether the pulses represent a “0” or a “1” for binary communication. Therefore, the transmitter and receiver are coordinated to send and receive pulses with an accuracy of trillionths of a second.

Ultra-wideband (UWB) utilizes millions of narrow pulses each second that are capable of obtaining accurate readings of location and distance. Because the pulses travel at the speed of light at about one foot in a billionth of a second, measuring the delay in the arrival of an expected pulse provides an extremely accurate way to determine distance from a transmitter to a receiver. Therefore, all UWB signals inherently contain distance information. Another advantage of UWB is that it is capable of transmission through objects and structures, and is ideal for applications inside building structures where there may be a number of walls. A relative location may be determined by the distances known of at least three other UWB transmitters via trilateration, also known as triangulation.

The logic circuit/processor 130 is provided with program code to automatically establish the wireless network based on the ultra-wideband (UWB) signals containing distance information transmitted by the plurality of wireless nodes making up the wireless network. The locations of each of the plurality of wireless nodes may be calculated based on the distance information obtained from each of the wireless nodes. According to an embodiment of the present invention, the logic circuit/processor 130 includes memory storage to store program code to operate the wireless node 100.

The wireless node 100 may include one or more sensors 150 that are capable of detecting a condition of an environment in which the wireless node is placed. For example, the sensor may be a light sensor to detect a level of light, a temperature sensor to detect temperature, an audio sensor to detect sound, or a motion sensor to detect movement in the area. The sensor 150 may also be adapted to detect operational parameters of the wireless node 100 itself, such as its battery/power level, or its radio signal strength. Sensor data may be transmitted from the wireless node 100 as a ultra-wideband (UWB) signal via the UWB transceiver 140 to, for example, another wireless node 140 or any other receiver.

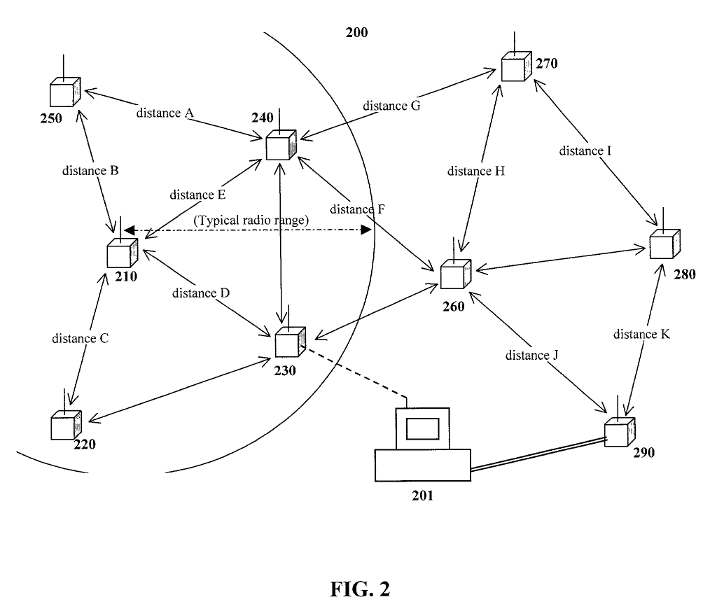

FIG. 2 illustrates a wireless self-surveying/self-configuring network according to an embodiment of the present invention. A plurality of wireless nodes 210, 220, 230, 240, 250, 260, 270, 280, 290 make up this wireless network 200. A computer system 201 is provided in the wireless network 200, and may function as a node as well, either wirelessly or wire-connected to one or more of the wireless nodes (e.g., wireless node 290). Referring to wireless node 210, distance information of nearby wireless nodes are received within its radio range. In the example illustrated in FIG. 2, wireless node 210 directly receives distance B information from wireless node 250, distance E information from wireless node 240, distance D information from wireless node 230, and distance C information from wireless node 220. Each of the wireless nodes 210, 220, 230, 240, 250, 260, 270, 280, 290 are capable of receiving, transmitting, and relaying distance information of any one of the wireless nodes 210, 220, 230, 240, 250, 260, 270, 280, 290, which may be utilized to calculate relative locations of each of the wireless nodes 210, 220, 230, 240, 250, 260, 270, 280, 290 within the wireless network 200. The distance information between each wireless node may be separately identified so that for a particular distance information, such as distance A, it is identified to correspond to the distance between wireless node 250 and wireless node 240.

The computer system 201, for example, may be provided to receive all of the distance information to calculate the relative locations of each of the wireless nodes 210, 220, 230, 240, 250, 260, 270, 280, 290 within the wireless network 200. The computer 201 is essentially another “node” within the network, although it may not be necessarily wireless. Trilateration, or triangulation, may be utilized to determine the relative locations. Ultimately, a known location of one of the wireless nodes 210, 220, 230, 240, 250, 260, 270, 280, 290 is required to determine the geographic coordinate locations of each of the wireless nodes 210, 220, 230, 240, 250, 260, 270, 280, 290 within the wireless network 200. The computer system 201 serves as a main system to store all of the information, including the distance information and the sensor data, transmitted from the wireless nodes 210, 220, 230, 240, 250, 260, 270, 280, 290 within the wireless network 200.

The logic circuit/processor 130 in each of the wireless nodes 210, 220, 230, 240, 250, 260, 270, 280, 290 includes program code capable of operating the wireless nodes, mainly in detecting and communicating with other wireless nodes to automatically establish the wireless network 200. The program code within the logic circuit/processor 130 is adapted to interface with the UWB transceiver 140 (see FIG. 1) to communicate with other wireless nodes 210, 220, 230, 240, 250, 260, 270, 280, 290, and to receive sensor data from the sensor 150 for transmission via the UWB transceiver 140 as well. According to one embodiment of the present invention, each wireless node 210, 220, 230, 240, 250, 260, 270, 280, 290 stores a list of its neighbor wireless nodes (e.g., 1-hop neighbors, 2-hop neighbors, best next hop for each 2-hop neighbor, etc.). For example, wireless node 230 is a 1-hop neighbor to wireless node 210, and wireless node 260 is a 2-hop neighbor to wireless node 210. In an embodiment of the present invention, the logic circuit/processor 130 includes an operating system having a network stack to permit each wireless node 210, 220, 230, 240, 250, 260, 270, 280, 290 to automatically establish themselves into a wireless network 200. Network protocol communications between the wireless nodes 210, 220, 230, 240, 250, 260, 270, 280, 290 are transmitted and received utilizing UWB signals (i.e., the UWB signals carry the data required to establish the wireless network 200).

Some wireless nodes utilized in the wireless network 200 may be more capable than others, i.e., have more functionality. For example, although the use of UWB signals allows each wireless node to provide distance information to other wireless nodes, the transmission radius range of each wireless node may be different. The wireless nodes that have better power supplies, such a continuous power line, may have more capabilities, including a greater transmission radius range than other wireless nodes having power constraints. The availability of a greater power source provides for the wireless node to have more features and more computing power. Moreover, some wireless nodes, especially those running on battery power only, may be capable of entering a “passive” or “sleep” mode, consuming power only as required to check for radio or sensor stimuli that may cause them to “wake up”.

Therefore, although all wireless nodes 210, 220, 230, 240, 250, 260, 270, 280, 290 are able to transmit distance information, all wireless nodes may not have the capability to process the distance information to, for example, calculate relative locations of the wireless nodes 210, 220, 230, 240, 250, 260, 270, 280, 290 within the wireless network 200. For example, the geographical coordinate location of a “more-capable” wireless node may be pre-surveyed so that the geographical coordinate locations of the other wireless nodes within the wireless network 200 may be determined therefrom.

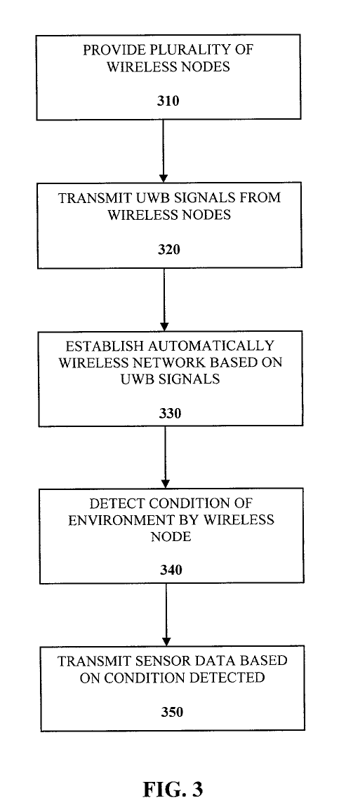

FIG. 3 illustrates a flow chart diagram of self-configuring a wireless network according to an embodiment of the present invention. A plurality of wireless nodes 310 is provided. For example, the wireless nodes may be installed into the walls of a building, embedded into a parking lot garage, or even dropped from an aircraft and scattered onto a field. Each of the wireless nodes transmit 320 ultra-wideband (UWB) signals to communicate with each other. Based on the UWB signals (which inherently contain distance information) transmitted by the wireless nodes, a wireless network is automatically established 330 by at least two of the wireless nodes. In an embodiment of the present invention, the wireless nodes may each include sensors to detect 340 a condition of the environment in which the wireless nodes are placed. For example, the condition may be temperature, movement, altitude, light level, sound level, etc. Sensor data of the condition detected may be transmitted 350 from the wireless node as a UWB signal. The sensor data may be ultimately relayed to a computer system to analyze the sensor data to determine the condition of the environment (e.g., temperature regions, light level regions, etc.) in which the wireless nodes are placed.

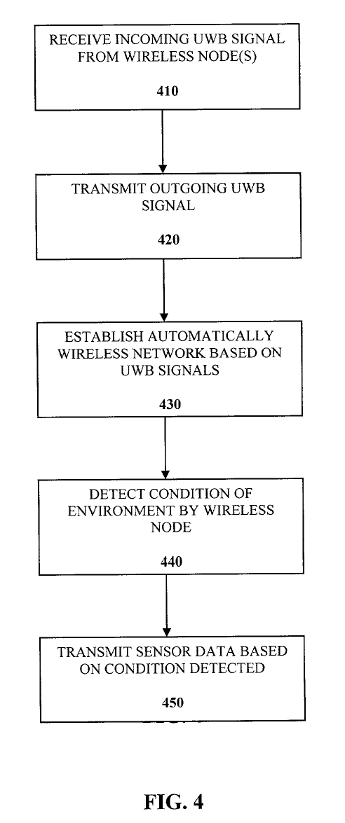

FIG. 4 illustrates a flow chart diagram of self-configuring a wireless network by a wireless node according to an embodiment of the present invention. Once the wireless node has been deployed, it is adapted to receive 410 an incoming ultra-wideband (UWB) signal from at least one other wireless node. The wireless node itself also transmits 420 an outgoing UWB signal to communicate with at least one other wireless node. Based on the UWB signals transmitted and received by the wireless nodes, a wireless network is automatically established 430 by at least two of the wireless nodes. The program code (software) resident within each wireless node is adapted to handle the communication between the plurality of wireless nodes to automatically establish the wireless network. In an embodiment of the present invention, the wireless nodes may each include sensors to detect 440 a condition of the environment in which the wireless nodes are placed. For example, the condition may be temperature, movement, altitude, light level, sound level, etc. Sensor data of the condition detected may be transmitted 450 from the wireless node as a UWB signal. The sensor data may be ultimately relayed to a computer system to analyze the sensor data to determine the condition of the environment (e.g., temperature regions, light level regions, etc.) in which the wireless nodes are placed.

In one particular application of the wireless network 200 (see FIG. 2) utilizing ultra-wideband (UWB) wireless nodes 210, 220, 230, 240, 250, 260, 270, 280, 290, the wireless nodes may be embedded or installed into a building structure, such as an office building, a parking lot, or a gym. The wireless nodes may be installed or embedded within a building structure without knowing their geographic coordinate locations. Although relative locations of the wireless nodes may be determined initially by the wireless network 200, geographic coordinate locations of the wireless nodes may be determined once the geographic coordinate location of at least one of the wireless nodes is determined. The wireless nodes are preferably positioned so that each wireless node is in communication with at least one other wireless node.

In a specific embodiment of the present invention, the wireless nodes may be installed in an office building floor with motion detector sensors. Therefore, once the wireless network 200 is automatically configured, it is possible to remotely determine whether a particular conference room on a floor is empty and available from a desktop computer, laptop computer, a personal digital assistant (PDA), etc. Temperature sensors, for example, may be included in a wireless node to generate a temperature map of an office floor. Optical/light sensors, for example, may be included in a wireless node to generate a floor map to determine which rooms have lights turned on or off. In another embodiment, wireless nodes having the appropriate sensors may be deployed within a building structure to monitor earthquakes, or even report damage resulting from earthquakes.

When utilized in a gym setting, motion detector sensors may determine how many people are in the gym, or even more specifically, whether a particular station is open and available (e.g., is the treadmill free?). Moreover, the ultra-wideband (UWB) wireless network 200 may also be utilized in a parking lot, for example. Each parking lot space may have a wireless node monitoring the space, using an ultrasound sensor, for example. A driver driving into a parking lot may be able to remotely access (using an on-board computer, a cellular telephone, a PDA, a laptop computer, etc., having a wireless connection) a map of available parking spaces. Therefore, the closest parking space available may be located without having to drive up and down each row of the parking lot. The UWB wireless network 200 is not limited to only these applications, as numerous implementations may be contemplated.

In another embodiment of the present invention, wireless nodes may be embedded into containers or items that need to be tracked, for example, in a warehouse setting. Accordingly, the warehouse may also be embedded with wireless nodes to establish the wireless network 200, and the items or containers that need to be tracked may be determined based on the relative locations of the wireless nodes embedded within the items or containers. Especially if the geographic coordinate location of one of the wireless nodes is already determined (such as that of a stationary wireless node embedded within a wall of the warehouse), then a real-time location tracking map may be generated based on the UWB signals received from the wireless nodes within the wireless network 200.

According to another particular embodiment of the present invention, a plurality of wireless nodes may be dropped from an aircraft and scattered across an open field, the wireless nodes being configured with sensors, for example, to detect temperature to assist in firefighting and determining the path of a fire, or to detect motion, so as to search for a missing person. The wireless nodes once deployed automatically establish the wireless network 200 to provide data to, for example, a main system computer 201.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed:

1. A self-configuring wireless network, comprising:
a plurality of wireless nodes each having
an ultra-wideband (UWB) wireless transceiver, and
a logic circuit adapted to automatically establish the wireless network with
at least another of the plurality of wireless nodes based on UWB signals having
distance information transmitted by the plurality of wireless nodes; and
a computer system capable of receiving the distance information transmitted from at least one of the plurality of wireless nodes and calculating locations of the plurality of wireless nodes.

2. The self-configuring wireless network according to claim 1, wherein the plurality of wireless nodes each further includes a power source.

3. The self-configuring wireless network according to claim 2, wherein the power source is a battery.

4. The self-configuring wireless network according to claim 2, wherein the power source is a continuous power supply.

5. The self-configuring wireless network according to claim 1, wherein the plurality of wireless nodes each further include a sensor to detect a condition of an environment in which each one of the wireless nodes are placed, and the UWB transceiver transmits sensor data based on the condition of the environment detected.

6. The self-configuring wireless network according to claim 1, wherein the computer system calculates the locations of the plurality of wireless nodes via triangulation.

7. A self-configuring wireless sensor network, comprising:
a plurality of wireless nodes each having
an ultra-wideband (UWB) wireless transceiver,
a logic circuit adapted to automatically establish the wireless network with
at least another of the plurality of wireless nodes based on UWB signals having
distance information transmitted by the plurality of wireless nodes, and
a sensor to detect a condition of an environment in which each one of the
wireless nodes are placed, wherein the UWB transceiver transmits sensor data
based on the condition of the environment detected; and
a computer system capable of receiving the distance information and the sensor data transmitted from at least one of the plurality of wireless nodes and calculating locations of the plurality of wireless nodes.

8. The self-configuring wireless network according to claim 7, wherein the plurality of wireless nodes each further includes a power source.

9. The self-configuring wireless network according to claim 8, wherein the power source is a battery.

10. The self-configuring wireless network according to claim 8, wherein the power source is a continuous power supply.

11. The self-configuring wireless network according to claim 7, wherein the computer system calculates the locations of the plurality of wireless nodes via triangulation.

12. A method of self-configuring a wireless network having a plurality of wireless nodes, the method comprising:
transmitting ultra-wideband (UWB) signals having distance information from the plurality of wireless nodes; and
establishing automatically the wireless network with at least two of the plurality of wireless nodes based on the UWB signals having distance information.

13. The method according to claim 12, wherein each one of the wireless nodes includes a power source, an ultra-wideband (UWB) wireless transceiver, and a logic circuit.

14. The method according to claim 12, further including calculating locations of the plurality of wireless nodes based on the distance information.

15. The method according to claim 14, wherein the locations of the plurality of wireless nodes are calculated via triangulation.

16. The method according to claim 13, wherein the power source is a battery.

17. The method according to claim 13, wherein the power source is a continuous power supply.

18. The method according to claim 12, further including detecting a condition of an environment in which each one of the wireless nodes are placed by a sensor within each one of the plurality of wireless nodes.

19. The method according to claim 18, further including transmitting sensor data based on the condition of the environment detected.

20. A method of self-configuring a wireless network by a wireless node, comprising:
receiving an incoming ultra-wideband (UWB) signal having distance information from at least one of a plurality of wireless nodes;
transmitting an outgoing UWB signal having distance information; and
establishing automatically the wireless network with the at least another of the plurality of wireless nodes based on the incoming UWB signal having distance information.

21. The method according to claim 20, wherein each one of the wireless nodes includes a power source, an ultra-wideband (UWB) wireless transceiver, and a logic circuit.

22. The method according to claim 20, further including calculating locations of the plurality of wireless nodes based on the distance information.

23. The method according to claim 22, wherein the locations of the plurality of wireless nodes are calculated via triangulation.

24. The method according to claim 21, wherein the power source is a battery.

25. The method according to claim 21, wherein the power source is a continuous power supply.

26. The method according to claim 20, further including detecting a condition of an environment in which the wireless node is placed.

27. The method according to claim 26, further including transmitting sensor data based on the condition of the environment detected.

28. A program code storage device, comprising:
a machine-readable storage medium; and
machine-readable program code, stored on the machine-readable storage medium, having instructions to
receive an incoming ultra-wideband (UWB) signal having distance information from at least one of a plurality of wireless nodes,
transmit an outgoing UWB signal having distance information, and
establish automatically a wireless network with the at least another of the plurality of wireless nodes based on the incoming UWB signal having distance information.

29. The program code storage device according to claim 28, wherein the machine-readable program code further includes instructions to calculate locations of the plurality of wireless nodes based on the distance information.

30. The program code storage device according to claim 29, wherein the locations of the plurality of wireless nodes are calculated via triangulation.

31. The program code storage device according to claim 28, wherein the machine-readable program code further includes instructions to detect a condition of an environment in which the wireless node is placed by a sensor within the wireless node.

32. The program code storage device according to claim 31, wherein the machine-readable program code further includes instructions to transmit sensor data based on the condition of the environment detected.

33. A wireless node capable of self-configuring a wireless network, comprising:
a power source to provide power to the wireless node;
an ultra-wideband (UWB) transceiver;
an antennae coupled to the UWB transceiver; and
a logic circuit adapted to automatically establish the wireless network with at least one of a plurality of wireless nodes based on UWB signals having distance information transmitted by the plurality of wireless nodes, wherein locations of the plurality of wireless nodes are calculated based on the distance information.

34. The wireless node according to claim 33, wherein the power source is a battery.

35. The wireless node according to claim 33, wherein the power source is a continuous power supply.

36. The wireless node according to claim 33, wherein the wireless node further includes a sensor to detect a condition of an environment in which the wireless node is placed, and the UWB transceiver transmits sensor data based on the condition of the environment detected.

37. The wireless node according to claim 33, wherein the locations of the plurality of wireless nodes in real space are calculated by a computer system.

38. The wireless node according to claim 33, wherein the locations of the plurality of wireless nodes are calculated via triangulation.
